(19) United States
(12) Patent Application Publication
(10) Pub. No.: US 2006/0125815 A1
(43) Pub. Date: Jun. 15, 2006

(54) Method and device for controlling display device

(75) Inventor: Seiji Ohtake, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/353,202

(22) Filed: Feb. 14, 2006

Related U.S. Application Data
(63) Continuation of application No. PCT/JP03/10344, filed on Aug. 14, 2003.

(51) Int. Cl. G09G 5/00

(52) U.S. Cl. 345/204; 710/36; 713/600

(57) ABSTRACT

Displaying by a display device is controlled by outputting a clock signal and an image signal to the display device. A clock signal and an image signal are prepared and stability of the clock signal is monitored by comparing a predetermined parameter relating to the clock signal with a threshold value. The clock signal is supplied to the display device only when it is determined that the clock signal is stable.

### BACKGROUND OF THE INVENTION

1. Field of the Invention

The present invention relates to a method and a device used for controlling displaying by a display device.

2. Description of the Related Art

In recent years, there is a great demand for smaller, thinner, light-weight, and compact electronic devices or electronic home appliances. For example, the liquid crystal displays (LCDs) are now rapidly replacing the cathode ray tubes (CRTs). A control device is used to control displaying by a display device.

FIG. 3 is a block diagram of a conventional control device of this type. The control device includes a graphic controller 10 and an LCD 20. The LCD can be other display device. The graphic controller 10 supplies an image signal S_{g} and clock signal S_{c} to the LCD 20 to control the driving of the LCD 20. The clock signal S_{c} is a signal that generates reference timing of displaying images on the LCD 20 corresponding to the image signal S_{g}. The frequency of this clock signal S_{c} is rated as 20 megahertz to 68 megahertz.

Upon receiving a clock signal S_{c} and image signal S_{g}, the LCD 20 displays an image corresponding to the image signal S_{g} at the reference timing corresponding to the clock signal S_{c}.

However, the clock signal S_{c} is not stable at the time of startup. As shown in FIG. 4, generally an unstable clock signal S_{c} is output between power-on time t₀ and time t₁ (200 microseconds) before the frequency reaches the rated threshold frequency fₜₕ (=20 megahertz).

When the clock signal S_{c} is not stable, an image can not be properly displayed on the LCD 20.

Japanese Patent Application Laid-open No. 2002-297108 discloses a related art.

### SUMMARY OF THE INVENTION

It is an object of the present invention to at least solve the problems in the conventional technology.

According to an aspect of the present invention, a control device for controlling displaying by a display device by outputting a clock signal and an image signal to the display device includes a signal preparing unit that prepares a clock signal and an image signal; a monitoring unit that monitors stability of prepared clock signal by comparing a predetermined parameter relating to the clock signal with a threshold value; and a signal supplying unit that supplies the image signal to the display device and supplies the clock signal to the display device only when the monitoring unit determines that the clock signal is stable.

According to another aspect of the present invention, a method of controlling displaying by a display device by outputting a clock signal and an image signal to the display device includes preparing a clock signal and an image signal; monitoring stability of prepared clock signal by comparing a predetermined parameter relating to the clock signal with a threshold value; and supplying the image signal to the display device and supplying the clock signal to the display device only when it is determined at the monitoring that the clock signal is stable.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a control device according to an embodiment of the present invention;

FIG. 2 is a graph for explaining the characteristics of a converting unit shown in FIG. 1;

FIG. 3 is a block diagram of a conventional control device; and

FIG. 4 is a graph for explaining an unstable clock signal.

### DETAILED DESCRIPTION OF THE PREFERRED EMBODIMENTS

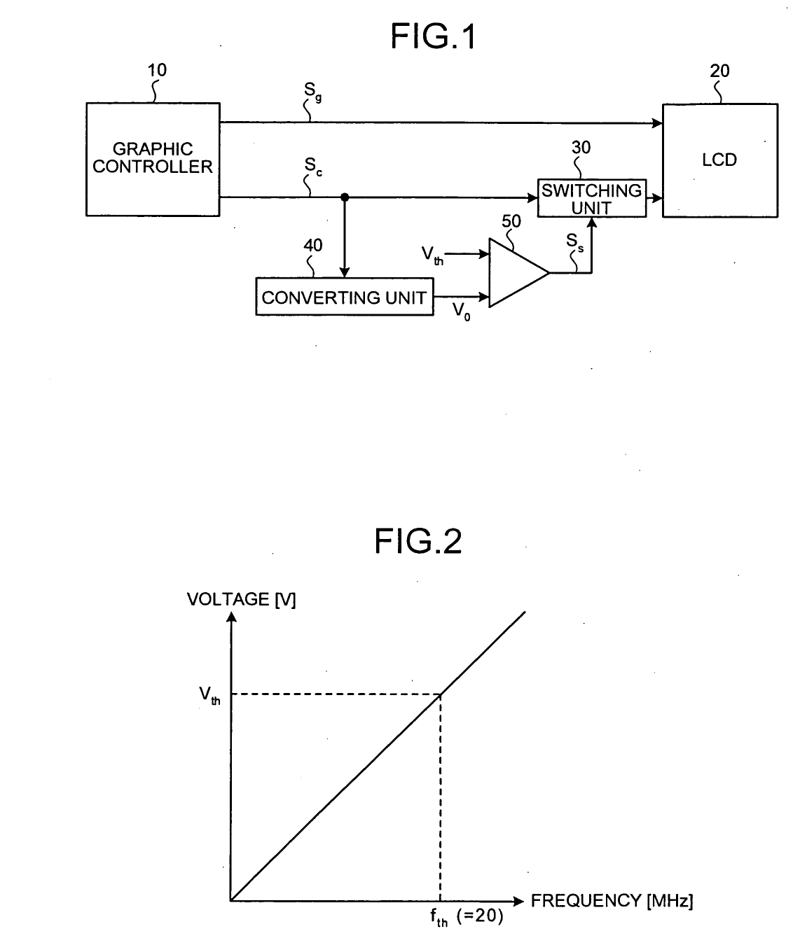

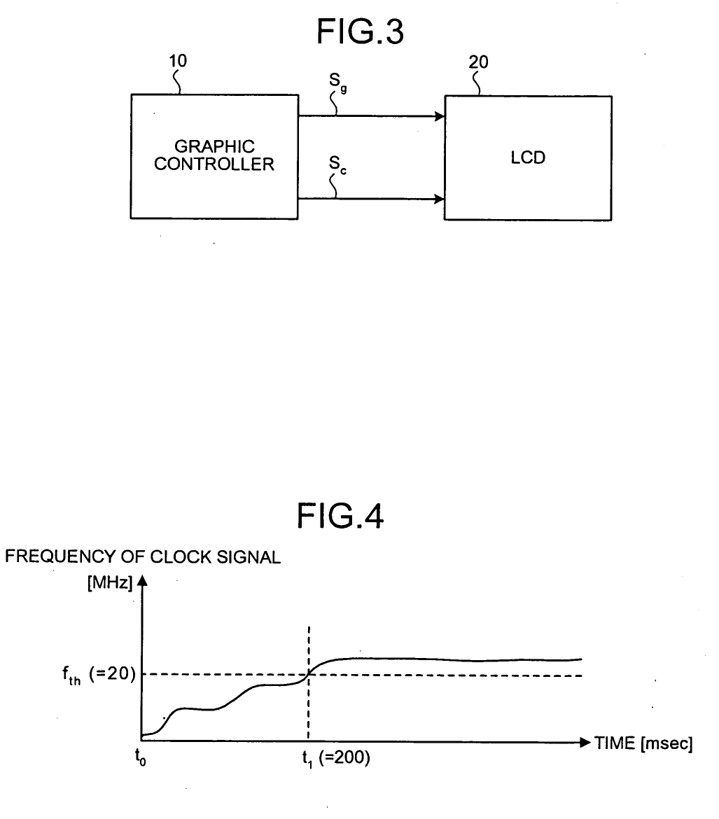

Exemplary embodiments of the present invention will be explained in detail by referring to the accompanying drawings. FIG. 1 is a block diagram of a control device according to an embodiment of the present invention. The same reference numerals are assigned to the units corresponding to the units in FIG. 3.

The control device includes the graphic controller 10, the LCD 20 a switching unit 30, a converting unit 40, and a comparator 50 are newly added to the structure.

The switching unit 30 is provided between the graphic controller 10 and the LCD 20, and switch-controlled by a switch control signal SS supplied from the comparator 50. More specifically, when the switch control signal SS corresponds to value 1, the switching unit 30 is turned on to supply the clock signal S_{c} of the graphic controller 10 to the LCD 20.

On the other hand, when the switch control signal SS corresponds to value 0, the switching unit 30 is turned off and does not supply the clock signal S_{c} of the graphic controller 10 to the LCD 20.

The converting unit 40 converts the frequency of the clock signal S_{c} supplied by the graphic controller 10 to a voltage V₀ in accordance with conversion property shown in FIG. 2. The comparator 50 compares the voltage V₀ supplied by the converting unit 40, with the predetermined threshold voltage Vₜₕ, and outputs a switch control signal Sₛ (0 or 1) to the switching unit 30, corresponding to the comparison result.

More specifically, when the voltage V₀ does not reach the predetermined threshold voltage Vₜₕ, the comparator 50 outputs the switch control signal Sₛ (=0) to the switching unit 30. On the other hand, when the voltage V₀ is equal to or greater than the predetermined threshold voltage Vₜₕ, the comparator 50 outputs the switch control signal SS (=1) to the switching unit 30.

The predetermined threshold voltage Vₜₕ corresponds to the threshold frequency fₜₕ shown in FIG. 2 and the threshold frequency fₜₕ shown in FIG. 4. In other words, the comparator in FIG. 1 determines whether the frequency of the clock signal S_{c} (voltage V₀) is lower than the threshold frequency fₜₕ (threshold voltage Vₜₕ).

The graphic controller 10, the switching unit 30, the converting unit 40, and the comparator 50 can be provided in the computer device. On the other hand, the graphic controller 10, the switching unit 30, the converting unit 40, and the comparator 50 can be provided in a display device configured to be connected to the computer device.

When the power is turned on at the time to shown in FIG. 4, the graphic controller 10 supplies an image signal S_{g} to the LCD 20, and a clock signal S_{c} to both the switching unit 30 and the converting unit 40. At this stage, the frequency of the clock signal S_{c} is below 20 megahertz and the signal is still unstable.

The converting unit 40 converts the frequency of the clock signal S_{c} (which is below 20 megahertz) to the voltage V₀ in accordance with the conversion property shown in FIG. 2 and outputs the voltage to the comparator 50. Because the voltage V₀ has not reached the threshold voltage Vₜₕ, the comparator 50 outputs the switch control signal Sₛ (=0) to the switching unit 30.

The switching unit 30 does not supply the clock signal S_{c} to the LCD 20 because the switch control signal S_{c} is 0. The LCD 20, which does not receive the clock signal S_{c}, does not perform any image display. Thus, no disturbance occurs on the screen, unlike in the conventional technology.

The frequency of the clock signal S_{c} described hereinafter is lower than the threshold frequency fₜₕ for a period of time between the time to and immediately before the time t₁ shown in FIG. 4, during which the switching unit 30 does not supply a clock signal S_{c} to the LCD 20.

At the time t₁ when the frequency of the clock signal S_{c} reaches or exceeds the threshold voltage fₜₕ, the voltage V₀ supplied from the converting unit 40 to the comparator 50 reaches or exceeds the threshold voltage Vₜₕ.

Because the voltage V₀ is equal to or greater than the threshold voltage Vₜₕ, the comparator 50 changes the switch control signal Ss that is being output to the switching unit 30, from 0 to 1. Then, the switching unit 30 supplies the clock signal S_{c} that is equal to or greater than the threshold frequency fₜₕ (as rated) to the LCD 20. The LCD 20 described hereinafter displays an image that corresponds to the image signal S_{g} based on the rated clock signal S_{c}.

As explained above, according to the embodiment, the voltage V₀ that corresponds to the frequency of the clock signal S_{c} (predetermined parameter) is compared with the threshold voltage Vₜₕ that corresponds to the threshold frequency fₜₕ. The stability of the frequency of the clock signal S_{c} supplied to the LCD 20 is thereby monitored (lower than the threshold frequency fₜₕ: unstable, equal to or higher than the threshold frequency fₜₕ: stable). If the clock signal S_{c} is in an unstable state, the clock signal S_{c} is not supplied to the LCD 20, while if the clock signal S_{c} is in a stable state, the clock signal S_{c} is supplied to the LCD 20. Therefore, screen disturbance associated with the instability of the clock signal S_{c} is prevented from occurring.

An embodiment of the present invention has been described with reference to the drawings. Examples of specific structures, however, are not limited to this embodiment, and the present invention can be embodied in various modes where modifications are added to the design as long as they do not depart from the gist of the invention.

For instance, the invention is not limited to controlling display of an LCD. The invention can be used to control different types of displays, such as plasma displays and CRTs.

As explained above, according to the embodiments, screen disturbance resulting from an instable clock signal can be prevented from occurring.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control device for controlling displaying by a display device by outputting a clock signal and an image signal to the display device, comprising:
a signal preparing unit that prepares a clock signal and an image signal;
a monitoring unit that monitors stability of prepared clock signal by comparing a predetermined parameter relating to the clock signal with a threshold value; and
a signal supplying unit that supplies the image signal to the display device and supplies the clock signal to the display device only when the monitoring unit determines that the clock signal is stable.

2. The control device according to claim 1, wherein the parameter is a frequency of the clock signal.

3. The control device according to claim 1, wherein the monitoring unit periodically monitors the prepared clock signal.

4. The control device according to claim 1, wherein the monitoring unit monitors the clock signal at the time of turning on power of the device.

5. The control device according to claim 1, wherein the display device is a liquid crystal display.

6. A method of controlling displaying by a display device by outputting a clock signal and an image signal to the display device, comprising:
preparing a clock signal and an image signal;
monitoring stability of prepared clock signal by comparing a predetermined parameter relating to the clock signal with a threshold value; and
supplying the image signal to the display device and supplying the clock signal to the display device only when it is determined at the monitoring that the clock signal is stable.

7. The method according to claim 6, wherein the parameter is a frequency of the clock signal.

8. The method according to claim 6, wherein the monitoring includes periodically monitoring the prepared clock signal.

9. The method according to claim 6, wherein the monitoring includes monitoring the clock signal at the time of turning on power of the device.

10. The method according to claim 6, wherein the display device is a liquid crystal display.
